(19) United States
(12) Patent Application Publication
(10) Pub. No.: US 2020/0225398 A1
(43) Pub. Date: Jul. 16, 2020

(54) LIGHT GUIDE ASSEMBLY, BACKLIGHT MODULE, AND DISPLAY PANEL

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: YAN-NI ZHANG, Yantai (CN); CHIA-HUANG CHANG, New Taipei (TW); CHIH-HSIUNG YEH, New Taipei (TW)

(21) Appl. No.: 16/276,929

(22) Filed: Feb. 15, 2019

(30) Foreign Application Priority Data
Jan. 15, 2019 (CN) 201910037552.2

(51) Int. Cl. F21V 8/00; G02F 1/1335

(52) U.S. Cl. CPC G02B 6/0031; G02B 6/0025; G02B 6/0066; G02F 1/133602; G02B 6/0016

(57) ABSTRACT

A light guide assembly is configured to diffuse a side-entry backlight and uniformly emit a surface light. The light guide assembly includes a light guide plate, a reflective sheet, and an adhesive layer. The light guide plate includes a light incident surface, a light output surface, and a bottom surface. The reflective sheet reflects the backlight emitted from the bottom surface. The light output surface is opposite to the bottom surface. The light incident surface is coupled between the light output surface and the bottom surface. The backlight enters the light guide plate from the light incident surface. The bottom surface includes a bonding region and a scattering region. The bonding region is located on at least one peripheral side of the bottom surface. The adhesive layer is adhered between the reflective sheet and the bonding region of the light guide plate.

### FIELD

The subject matter herein generally relates to light guide assemblies, and more particularly to a light guide assembly of a backlight module of a display panel.

### BACKGROUND

Generally, a backlight module of a display device includes a light source and a light guide plate. The light guide plate guides a transmission direction of a light beam emitted from the light source and converts a line light source or a point light source into a surface light source. At present, the ultra-thin liquid crystal display mostly adopts a backlight module 10 as shown in FIG. 1, and a reflective sheet 120 of the entire optical adhesive layer 130 is completely adhered to the light guide plate 110. The optical adhesive layer 130 absorbs a portion of the backlight emitted by the light source 101, and the optical adhesive layer 130 and the light guide plate 110 closely adhere to each other, which also affects the backlight reflected back to the light guide plate 110 through the reflective sheet 120. A decrease in the light output of the microstructures results in a loss of light energy. In addition, full-plane bonding is difficult to rework, and the process of tearing the optical adhesive layer 130 away from the light guide plate 110 can easily cause secondary damage to the scattering microstructures.

### BRIEF DESCRIPTION OF THE DRAWINGS

Implementations of the present disclosure will now be described, by way of embodiments, with reference to the attached figures.

FIG. 1 is a cross-sectional view of a reflective sheet and a light guide plate of a conventional backlight module.

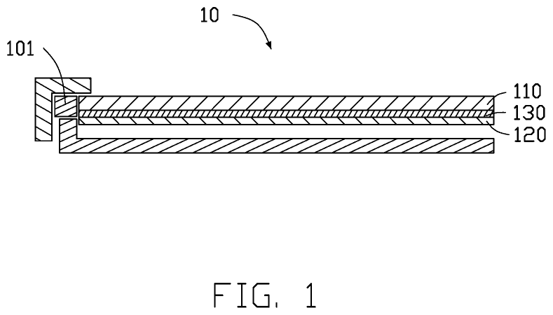

FIG. 2 is a cross-sectional view of an embodiment of a backlight module.

FIG. 3 is a diagram of a bottom surface of a light guide plate of a light guide assembly.

FIG. 4 is similar to FIG. 3, but showing the bottom surface of the light guide plate of the light guide assembly according to another embodiment.

FIG. 5 is a diagram showing a distribution of scattering microstructures when the scattering microstructure are formed by ink.

FIG. 6 is a cross-sectional view taken along line I-I of FIG. 4 of a light guide assembly when the scattering microstructures are formed by ink.

FIG. 7 is a diagram showing a distribution of scattering microstructures when the scattering microstructures are formed by grooves.

FIG. 8 is a cross-sectional view taken along line I-I of FIG. 4 of a light guide assembly when the scattering microstructures are formed by grooves.

FIG. 9 is similar to FIG. 8, but showing a cross-sectional structural view of the light guide assembly according to another embodiment when the scattering microstructures are formed by grooves.

FIG. 10 is a schematic diagram of an embodiment of a display device.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

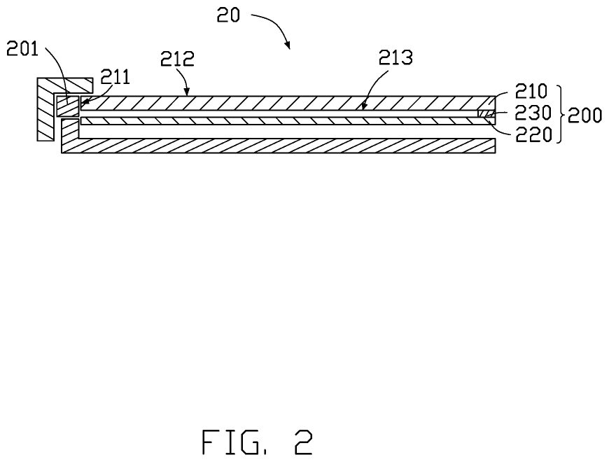

FIG. 2 shows an embodiment of a backlight module 20 including a light guide assembly 200 and a light source 201. The light source 201 is used to emit a backlight. The light guide assembly 200 is configured to diffuse a side-entry backlight and uniformly emit a surface light.

The light guide assembly 200 includes a light guide plate 210, a reflective sheet 220, and an adhesive layer 230. The light guide plate 210 is used to diffuse the backlight emitted by the light source 201. The reflective sheet 220 is arranged on one side of the light guide plate 210 and is configured to reflect the backlight emitted from the light guide plate 210, so that the backlight can be uniformly emitted from a side of the light guide plate 210 facing away from the reflective sheet 220. The adhesive layer 230 is used to bond the light guide plate 210 to the reflective sheet 220.

In one embodiment, the light guide plate 210 is a glass plate. In another embodiment, the light guide plate 210 can be made of plastic, such as acrylic. A shape of the light guide plate 210 may be rectangular, circular, elliptical, triangular, or any other shape. The light guide plate 210 includes a light incident surface 211, a light output surface 212, and a bottom surface 213. The light output surface 212 is opposite to the bottom surface 213. The light incident surface 211 is coupled between the light output surface 212 and the bottom surface 213. The backlight enters the light guide plate 210 from the light incident surface 211. The light source 201 is arranged on a side of the light incident surface 211. The backlight emitted by the light source 201 is emitted from the backlight module 20 through the light incident surface 211 and the light output surface 212.

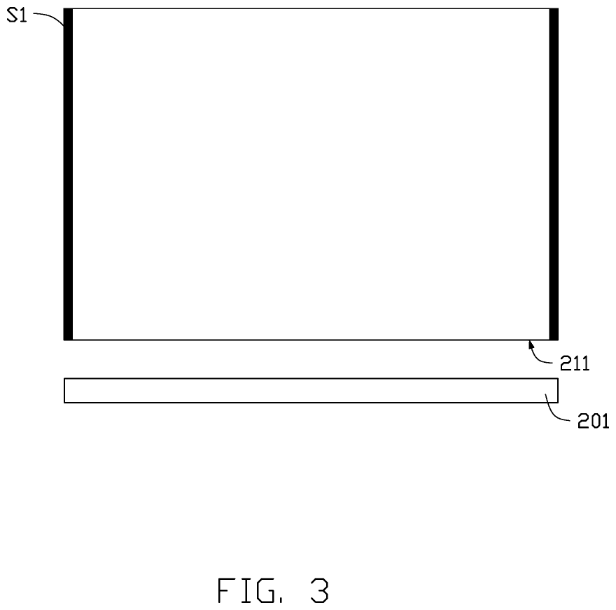

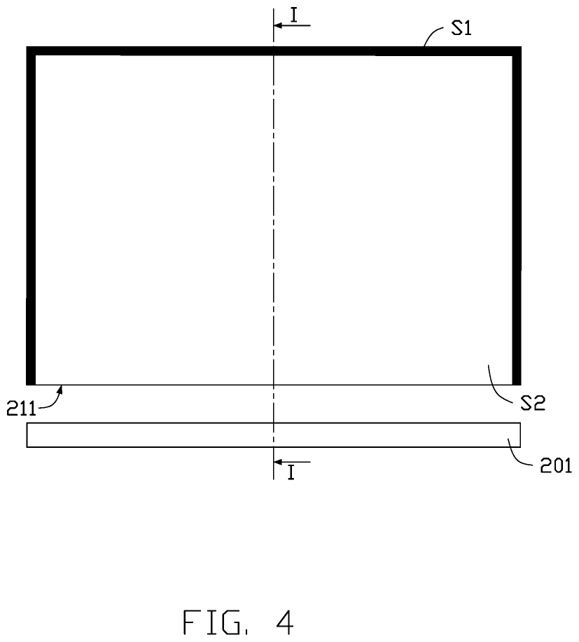

Referring to FIGS. 3 and 4, the bottom surface 213 includes a bonding region S1 and a scattering region S2 adjacent to the bonding region S1. The bonding region S1 is arranged on at least a peripheral side of the bottom surface 213. In one embodiment, the light guide plate 210 is rectangular, and the bottom surface 213 is a rectangular surface. The bonding region S1 is arranged on the bottom surface 213 on at least two peripheral sides of the light incident surface 211. Referring to FIG. 3, in an embodiment, the bonding region S1 is arranged on two opposite peripheral sides of the bottom surface 213. In another embodiment, as shown in FIG. 4, the bonding region S1 is further arranged on a peripheral side of the bottom surface 213 opposite the light incident surface 211. The scattering region S2 is a region of the bottom surface 213 not covered by the bonding region S1. The scattering region S2 includes a plurality of spaced apart scattering microstructures for scattering the backlight.

Since the backlight propagating within the light guide plate 210 continuously scatters on the scattering microstructures, a luminous flux of the backlight gradually attenuates along a propagation path, resulting in a decreased rate of light emission in a region of the light guide plate 210 further away from the light incident surface 211. A problem of uneven light distribution caused by the attenuation of the luminous flux during the propagation of the backlight can be improved by increasing a scattering effect by the scattering microstructures on the backlight at a distance further away from the light incident surface 211.

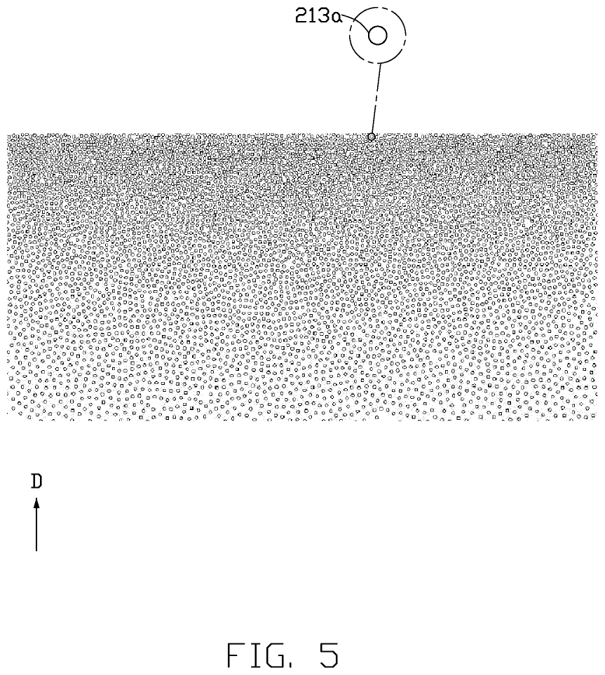

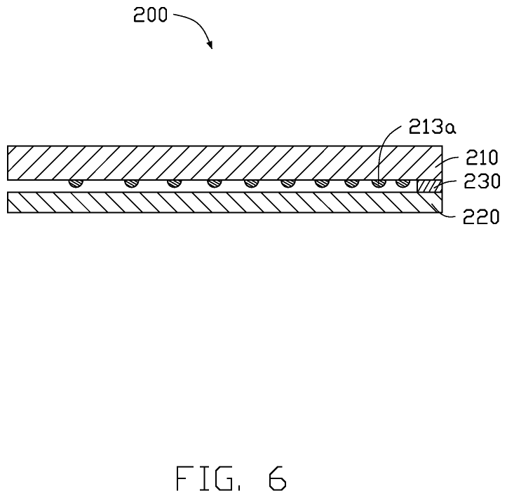

Referring to FIG. 5 and FIG. 6, scattering microstructures 213a of the scattering region S2 are formed by ink on the bottom surface 213. The ink can be formed on the light guide plate 210 by screen printing or printing. A density of the scattering microstructures 213a on the bottom surface 213 increases along a direction away from the light incident surface 211. The backlight emitted by the light source 201 propagates along a direction D.

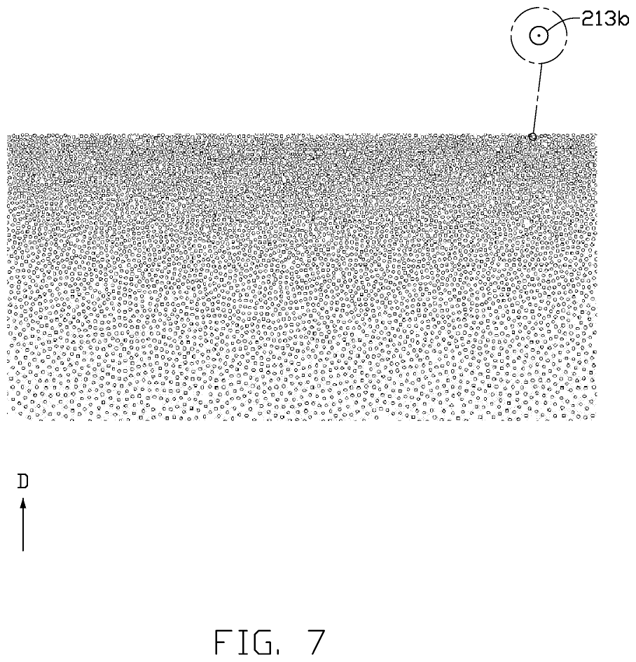

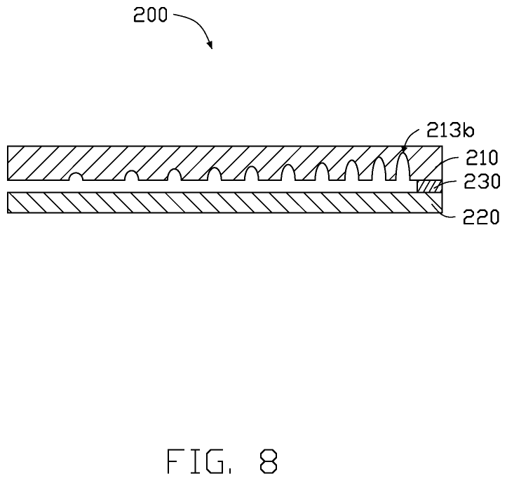

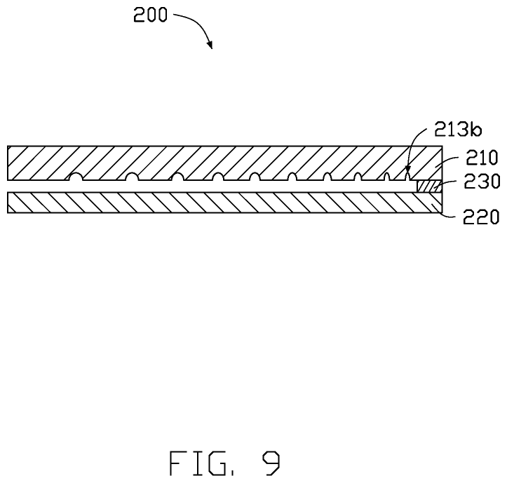

Referring to FIG. 7 and FIG. 8, the scattering microstructures 213b of the scattering region S2 are grooves recessed toward the light emitting surface 212, and a density of the scattering microstructures 213b on the bottom surface 213 increases along a direction away from the light incident surface 211. Referring to FIG. 8, in one embodiment, a depth of the grooves increases along the distance away from the light incident surface 211. A size of an opening of the grooves can be the same or different. In another embodiment, as shown in FIG. 9 a size of the opening of the grooves decreases along the distance away from the light incident surface 211. The depth of the grooves may be the same or different. The grooves may be formed by laser, hot pressing, etching, or the like, and a shape of the grooves may be semicircular, tapered, inverted pyramid, or other shapes according to actual requirements. In other embodiments, a type, density, size, and the like of the scattering microstructures can be adjusted according to actual requirements.

In the conventional backlight module, the type and distribution of the scattering microstructures on the light guide plate are specifically designed according to the type and formula of the bonded optical adhesive layer, and the light guide assembly 200 of the current disclosure is arranged on the light guide plate 210. There is no filling of the adhesive layer 230 between the scattering region S2 and the reflection sheet 220. It can be understood that the scattering microstructures in the light guide plate 210 are not limited to the manner as described in the embodiment, and a structure of the light guide plate 210 is simple.

Referring to FIG. 2, the adhesive layer 230 is bonded on the bonding region S1 of the light guide plate 210 to bond the bonding region S1 to the reflective sheet 220. The adhesive layer 230 is an optical solid glue. In one embodiment, the adhesive layer 230 is an Optically Clear Adhesive (OCA). In another embodiment, the adhesive layer 230 is a VHB double-sided tape composed of an acrylic substrate and an acrylic glue. In other embodiments, the adhesive layer 230 may be an acrylic foam double-sided tape or other solid glue having double-sided adhesiveness.

The backlight emitted by the light source 201 and incident on the light guide plate 210 may follow two optical paths. In a first optical path, the backlight is scattered by the scattering microstructures of the light guide plate 210, and the scattered backlight emits through the light emitting surface of the light guide plate 210. In a second optical path, after the backlight first passes through the bottom surface 213 of the light guide plate 210, the backlight passes through an air layer to the reflective sheet 220 and is reflected by the reflective sheet 220. The backlight reflected by the reflective sheet 220 propagates through the air layer along a direction away from the light source 201 to the scattering microstructures, and then the backlight enters the light guide plate 210 after being incident on the light scattering structures. In one embodiment, a thickness of the reflective sheet 220 is 40-300 micrometers. In other embodiments, a thickness of the adhesive layer 230 may be adjusted according to actual requirements.

Since the amount of light loss of the backlight propagating through air is much less than the amount of light loss of the backlight propagating through the adhesive layer 230, the light guide assembly 200 reduces the amount of light loss compared to the conventional backlight module having an optical sheet completely bonded to the reflective sheet and the light guide plate. The light guide assembly 200 reduces absorption of the backlight by the adhesive layer 230, thereby improving a lighting effect of the light guide assembly 200 and increasing a brightness by more than 10%. Furthermore, a required amount of optical solid glue in the adhesive layer 230 is reduced, thereby reducing a manufacturing cost of the backlight module 20, and secondary damage of the scattering microstructures during a rework process is prevented.

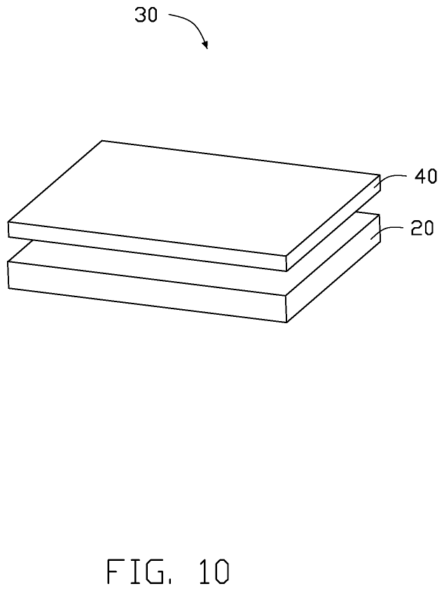

Referring to FIG. 10, a display device 30 includes the backlight module 20 and a display panel 40. The backlight emitted by the backlight module 20 forms an image to be displayed through the display panel 40.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

1. A light guide assembly configured to diffuse a side-entry backlight and uniformly emit a surface light, the light guide assembly comprising:
a light guide plate comprising a light incident surface, a light output surface, and a bottom surface;
a reflective sheet; and
an adhesive layer; wherein:
the light output surface is opposite to the bottom surface;
the light incident surface is between the light output surface and the bottom surface;
a backlight enters the light guide plate from the light incident surface;
the reflective sheet is configured to reflect the backlight emitted from the bottom surface;
the bottom surface comprises a bonding region and a scattering region, wherein the scattering region comprises scattering microstructures which are spaced apart from one another; the scattering microstructures are formed in a plurality of grooves recessed toward the light output surface, and cross sections of the grooves gradually transition from semicircles to ellipses with different sizes along a determined direction or gradually transition from ellipses with different sizes to semicircles along a determined direction;
the bonding region is located on at least one peripheral side of the bottom surface; and
the adhesive layer is adhered between the reflective sheet and the bonding region of the light guide plate.

2. The light guide assembly of claim 1, wherein:
the light guide plate is rectangular;
the bonding region is located on at least two peripheral sides of the bottom surface, the two peripheral sides of the bottom surface selected from two sides of the bottom surface not adjacent to the light incident surface.

3. The light guide assembly of claim 2, wherein the bonding region is located on two opposite peripheral sides of the bottom surface.

4. (canceled)

5. The light guide assembly of claim 1, wherein a density of the scattering microstructures on the bottom surface increases along a direction away from the light incident surface.

6. The light guide assembly of claim 1, wherein a depth of the grooves on the bottom surface increases along a direction away from the light incident surface.

7. The light guide assembly of claim 1, wherein a size of an opening of the grooves on the bottom surface decreases along a direction away from the light incident surface.

8. The light guide assembly of claim 1, wherein a thickness of the adhesive layer is 40 to 300 micrometers.

9. A backlight module comprising:
a light source configured to emit a backlight; and
a light guide assembly comprising:
a light guide plate comprising a light incident surface, a light output surface, and a bottom surface;
a reflective sheet; and
an adhesive layer; wherein:
the light output surface is opposite to the bottom surface;
the light incident surface is between the light output surface and the bottom surface;
the backlight enters the light guide plate from the light incident surface;
the backlight passes through the light incident surface and the light output surface;
the reflective sheet is configured to reflect the backlight emitted from the bottom surface;
the bottom surface comprises a bonding region and a scattering region, wherein the scattering region comprises scattering microstructures which are spaced apart from one another; the scattering microstructures are formed in a plurality of grooves recessed toward the light output surface, and cross sections of the grooves gradually transition from semicircles to ellipses with different sizes along a determined direction or gradually transition from ellipses with different sizes to semicircles along a determined direction;
the bonding region is located on at least one peripheral side of the bottom surface;
the adhesive layer is adhered between the reflective sheet and the bonding region of the light guide plate; and
the light source is located on a side of the light incident surface of the light guide plate.

10. The backlight module of claim 9, wherein:
the light guide plate is rectangular;
the bonding region is located on at least two peripheral sides of the bottom surface, the two peripheral sides of the bottom surface selected from two sides of the bottom surface not adjacent to the light incident surface.

11. The backlight module of claim 10, wherein the bonding region is located on two opposite peripheral sides of the bottom surface.

12. (canceled)

13. The backlight module of claim 9, wherein a density of the scattering microstructures on the bottom surface increases along a direction away from the light incident surface.

14. The backlight module of claim 9, wherein a depth of the grooves on the bottom surface increases along a direction away from the light incident surface.

15. The backlight module of claim 9, wherein a size of an opening of the grooves on the bottom surface decreases along a direction away from the light incident surface.

16. A display device comprising:
a display panel; and
a backlight module configured to emit a backlight through the display panel, the backlight module comprising:
a light source configured to emit the backlight; and
a light guide assembly comprising:
a light guide plate comprising a light incident surface, a light output surface, and a bottom surface;
a reflective sheet configured to reflect the backlight emitted from the bottom surface; and
an adhesive layer; wherein:
the light source is located on a side of the light incident surface of the light guide plate;
the backlight emitted by the light source passes through the light incident surface and the light output surface;
the light output surface is opposite to the bottom surface;
the light incident surface is coupled between the light output surface and the bottom surface;
the backlight enters the light guide plate from the light incident surface;
the bottom surface comprises a bonding region and a scattering region, wherein the scattering region comprises scattering microstructures which are spaced apart from one another; the scattering microstructures are formed in a plurality of grooves recessed toward the light output surface, and cross sections of the grooves gradually transition from semicircles to ellipses with different sizes along a determined direction or gradually transition from ellipses with different sizes to semicircles along a determined direction;
the bonding region is located on at least one peripheral side of the bottom surface; and
the adhesive layer is adhered between the reflective sheet and the bonding region of the light guide plate.

17. The display device of claim 16, wherein:
the light guide plate is rectangular;
the bonding region is located on at least two peripheral sides of the bottom surface adjacent to the light incident surface.

18. (canceled)

19. The display device of claim 16, wherein a density of the scattering microstructures on the bottom surface increases along a direction away from the light incident surface.

20. The display device of claim 16, wherein a depth of the grooves on the bottom surface increases along a direction away from the light incident surface.

21. The display device of claim 16, wherein a size of an opening of the grooves is same to each other and a depth of the grooves on the bottom surface increases along a direction away from the light incident surface.

22. The display device of claim 16, wherein a size of an opening of the grooves decreases along a direction away from the light incident surface.

23. The light guide assembly of claim 1, wherein a size of an opening of the grooves is same to each other and a depth of the grooves on the bottom surface increases along a direction away from the light incident surface.
